(19) United States
(12) Patent Application Publication
(10) Pub. No.: US 2025/0372895 A1
(43) Pub. Date: Dec. 4, 2025

(54) WIRE HARNESS

(71) Applicant: Yazaki Corporation, Tokyo (JP)

(72) Inventors: Hiroaki ONO, Shizuoka (JP); Toru SUZUKI, Shizuoka (JP); Saya UNNO, Shizuoka (JP)

(73) Assignee: Yazaki Corporation, Tokyo (JP)

(21) Appl. No.: 19/212,880

(22) Filed: May 20, 2025

(30) Foreign Application Priority Data
Jun. 3, 2024 (JP) 2024-089720

(51) Int. Cl. H01R 4/64; B60R 16/02; H01R 4/34; H01R 4/72

(52) U.S. Cl. CPC H01R 4/646; H01R 4/34; H01R 4/72; B60R 16/0215

(57) ABSTRACT

A wire harness includes a shield electric wire that has a braided member; a shield terminal that covers an outer peripheral surface of the shield electric wire and is grounded to a shield shell; a shield ring that is crimped and fixed to sandwich a folded portion of the braided member between the shield ring and the shield terminal; a packing performing sealing with respect to an outer peripheral surface of the first portion of the shield electric wire; and a shrink tube. The shrink tube integrally covers an outer peripheral surface of a second portion of the shield electric wire, an outer peripheral surface of the shield ring, and the outer peripheral surface of the shield terminal, and that performs sealing with respect to the outer peripheral surface of the second portion.

CROSS-REFERENCE TO RELATED APPLICATION(S)

The present application claims priority to and incorporates by reference the entire contents of Japanese Patent Application No. 2024-089720 filed in Japan on Jun. 3, 2024.

### BACKGROUND OF THE INVENTION

### 1. Field of the Invention

The present invention relates to a wire harness.

### 2. Description of the Related Art

As a technique related to a wire harness in the related art, for example, JP 2023-106 844 A discloses a wire harness. This wire harness includes a shield electric wire having a braided member; a shield terminal that covers an outer peripheral surface of the shield electric wire and is grounded to a grounding target; a shield ring that is crimped and fixed to a folded portion of the braided member folded along an outer peripheral surface of the shield terminal; and a shrink tube that integrally covers an outer peripheral surface of a portion of the shield electric wire positioned to be shifted in an axial direction from the shield ring, an outer peripheral surface of the shield ring, and the outer peripheral surface of the shield terminal, and performs sealing with respect to the outer peripheral surface of the shield electric wire.

By the way, in the wire harness disclosed in JP 2023-106 844 A described above, for example, there is room for further improvement in terms of appropriately suppressing the ingress of water to a crimped and fixed portion by the shield ring.

### SUMMARY OF THE INVENTION

The present invention has been made in view of the above circumstances, and an object thereof is to provide a wire harness capable of appropriately suppressing the ingress of water to a crimped and fixed portion by a shield ring.

In order to achieve the above mentioned object, a wire harness according to one aspect of the present invention includes a shield electric wire that has a braided member; a shield terminal that covers an outer peripheral surface of the shield electric wire, and is grounded to a grounding target; a shield ring that is crimped and fixed to sandwich a folded portion of the braided member between the shield ring and the shield terminal, the folded portion being folded along an outer peripheral surface of the shield terminal; a packing that has a packing main body that covers an outer peripheral surface of a first portion of the shield electric wire, the first portion being positioned closer to one end portion side of the shield electric wire in an axial direction than the shield ring, and has an inner peripheral lip portion that protrudes inward in a radial direction from an inner peripheral surface of the packing main body, and performs sealing with respect to an outer peripheral surface of the first portion; and a shrink tube that integrally covers an outer peripheral surface of a second portion of the shield electric wire, the second portion being positioned closer to the other end portion side in the axial direction than the shield ring, an outer peripheral surface of the shield ring, and the outer peripheral surface of the shield terminal, and that performs sealing with respect to the outer peripheral surface of the second portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exemplary perspective view illustrating a wire harness according to an embodiment;

FIG. 2 is an exemplary exploded perspective view illustrating the wire harness according to the embodiment;

FIG. 3 is an exemplary exploded perspective view illustrating a stacked body of the wire harness according to the embodiment; and

FIG. 4 is an exemplary cross-sectional view illustrating the wire harness according to the embodiment.

### DETAILED DESCRIPTION OF THE PREFERRED EMBODIMENTS

Hereinafter, an embodiment according to the present invention will be described in detail with reference to the drawings. Note that the present invention is not limited by the following embodiments. In addition, constituent elements in the following embodiments include those that can be easily replaced by those skilled in the art or those that are substantially the same. Note that in the present specification, ordinal numbers are used only to distinguish components, members, parts, positions, directions, and the like, and do not indicate order or priority.

### Embodiments

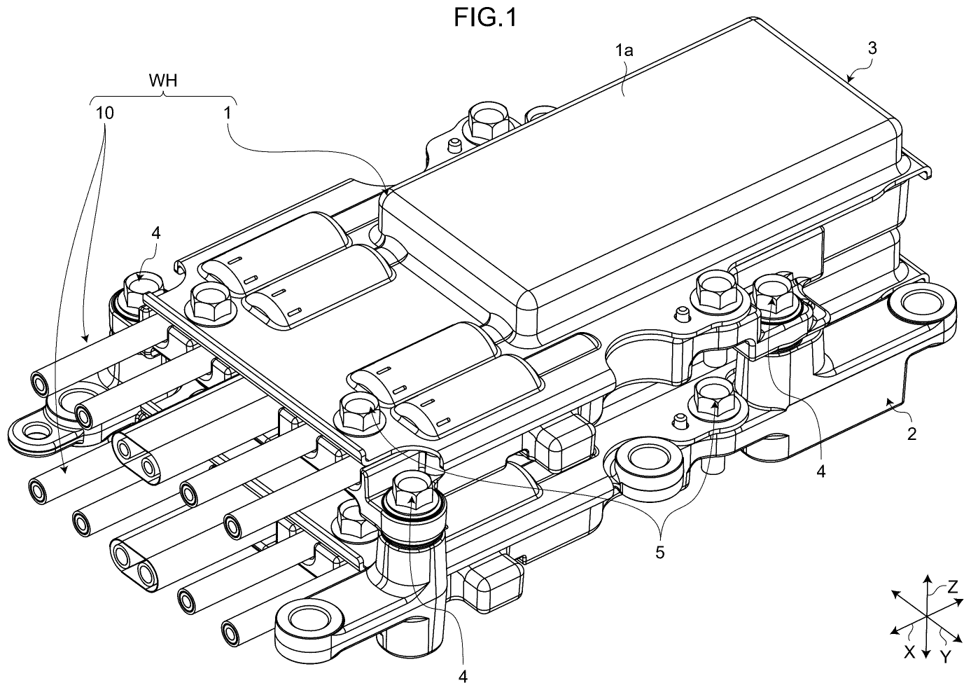

FIG. 1 is a perspective view illustrating a wire harness WH according to an embodiment. The wire harness WH of the present embodiment illustrated in FIG. 1 is incorporated in a vehicle such as an automobile. Here, for example, the wire harness WH is configured such that shield electric wires 10 as a plurality of electric wires used for power supply and signal communication are bundled to form a collective component, and the shield electric wires 10 are connected to each device by a connector or the like for connection between devices mounted on the vehicle. The wire harness WH of the present embodiment includes, for example, a plurality of shield electric wires 10 having conductivity, and a shield shell 1 provided at ends of the plurality of shield electric wires 10 and grounded to the shield electric wires 10. In the present embodiment, the shield shell 1 is an example of a grounding target. Note that the wire harness WH may further include a protector, a grommet, and the like.

Note that in the following description, among a first direction, a second direction, and a third direction intersecting each other, the first direction is referred to as an “axial direction X”, the second direction is referred to as a “width direction Y”, and the third direction is referred to as a “height direction Z”. Here, the axial direction X, the width direction Y, and the height direction Z are substantially orthogonal to each other. Typically, the axial direction X corresponds to an extending direction (axial direction) of the shield electric wire 10, an insertion direction of the shield electric wire 10 with respect to the shield shell 1, a longitudinal direction of the shield shell 1, and the like. Typically, the width direction Y corresponds to a radial direction of the shield electric wire 10, the width direction (left-right direction) of the shield shell 1, and the like. Typically, the height direction Z corresponds to the radial direction of the shield electric wire 10, the height direction (up-down direction) of the shield shell 1, a stacking direction of stacked bodies 2 and 3 described later, and the like. In addition, each direction used in the following description will be described as a direction in a state where the shield electric wires 10 are assembled to the shield shell 1 unless otherwise specified.

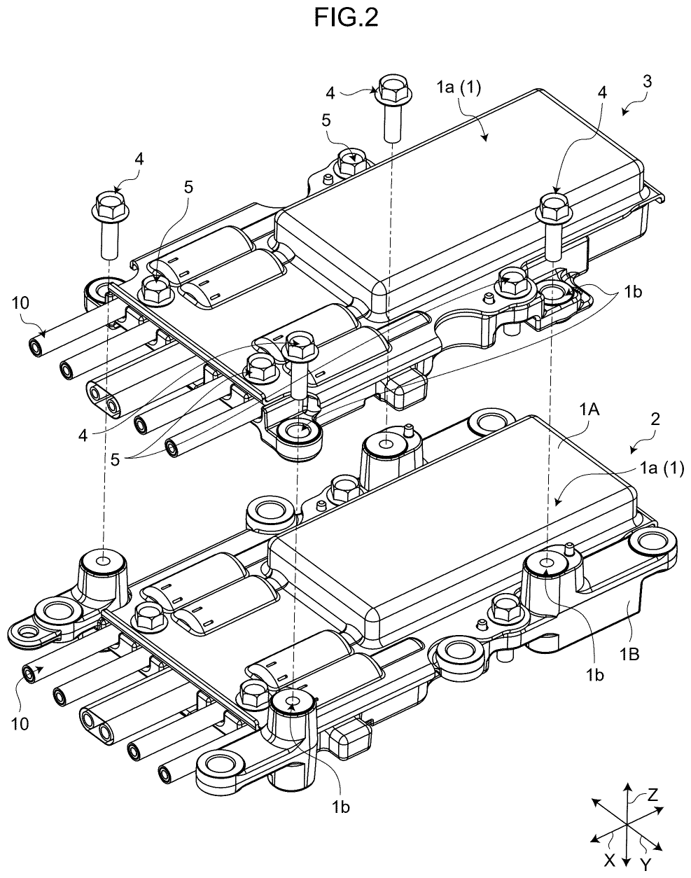

FIG. 2 is an exploded perspective view illustrating the wire harness WH. As illustrated in FIG. 2, the wire harness WH includes, for example, the plurality of stacked bodies 2 and 3 stacked along the height direction Z, and a plurality of fastening members 4 such as bolts for fastening the plurality of stacked bodies 2 and 3. In the present embodiment, the stacked bodies 2 and 3 are configured by substantially the same unit component (module). That is, the specifications of the stacked body 2 are substantially the same as the specifications of the stacked body 3. Here, the stacked body 2 is provided with an attachment portion 1b having a boss hole shape to which the fastening member 4 is fastened, the stacked body 3 is provided with the attachment portion 1b having an attachment hole shape into which the fastening member 4 is inserted, and the other configurations are substantially the same. The attachment portion 1b is provided, for example, at each of four corners of the stacked bodies 2 and 3.

Each of the stacked bodies 2 and 3 includes, for example, the plurality of shield electric wires 10 and the shield shell 1 that houses the plurality of shield electric wires 10. The shield shell 1 grounds the plurality of shield electric wires 10 and covers the periphery of the shield electric wire 10 to suppress leakage of noise or the like to the outside of the shield shell 1. The shield shell 1 is configured by, for example, a combination of a plurality of components. Here, as an example, the shield shell 1 includes an upper shell 1A and a lower shell 1B. Each of the upper shell 1A and the lower shell 1B is formed of, for example, a metal material having conductivity.

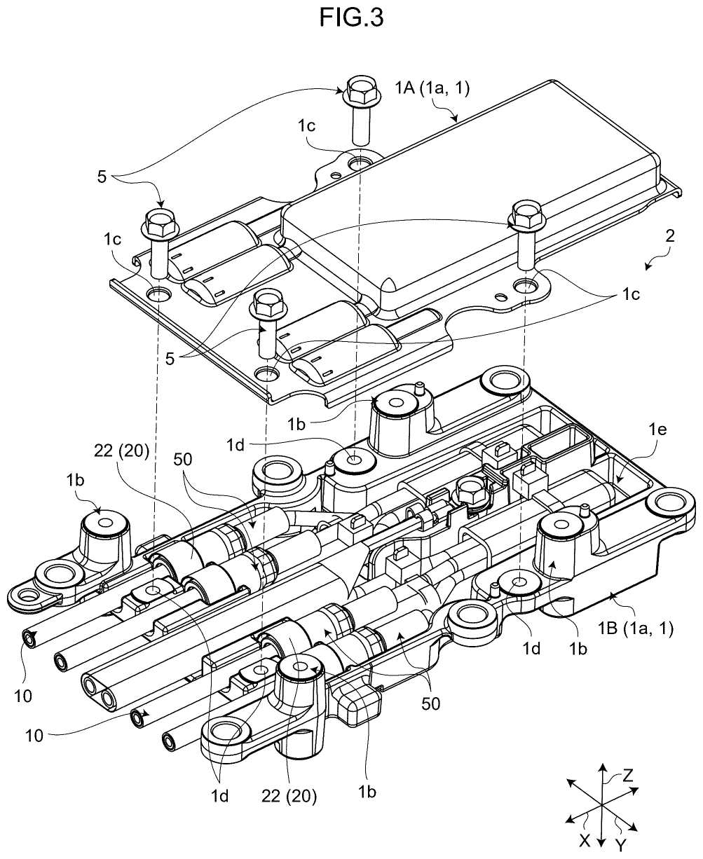

FIG. 3 is an exploded perspective view illustrating the stacked body 2. As illustrated in FIG. 3, the lower shell 1B is a portion of the shield shell 1 that covers the plurality of shield electric wires 10 from the other end portion side (lower side) in the height direction Z. The lower shell 1B is provided with a recessed housing space portion le that is open toward one end portion side (upper side) in the height direction Z and houses the plurality of shield electric wires 10. In the housing space portion le, the plurality of shield electric wires 10 are arranged side by side at intervals in the width direction Y. In addition, the lower shell 1B is provided with a plurality of fastening holes 1d to which fastening members 5 such as bolts are fastened along the height direction Z. The plurality of fastening holes 1d are provided, for example, near the attachment portions 1b at four corners of the lower shell 1B, and are fastened (integrated) to the upper shell 1A via the fastening members 5 fastened to the fastening holes 1d.

The upper shell 1A is a portion of the shield shell 1 that covers the plurality of shield electric wires 10 from one end portion side (upper side) in the height direction Z. The upper shell 1A covers the housing space portion le from the one end portion side (upper side) in the height direction Z in a state where the plurality of shield electric wires 10 are housed in the housing space portion 1e of the lower shell 1B. The upper shell 1A constitutes a main body portion 1a of the shield shell 1 together with the lower shell 1B. In addition, the upper shell 1A is provided with a plurality of insertion holes 1c into which the above-described fastening members 5 are inserted along the height direction Z. The plurality of insertion holes 1c are provided at positions corresponding to the plurality of fastening holes 1d of the lower shell 1B, for example. The fastening members 5 are fastened to the fastening holes 1d in a state of being inserted into the respective insertion holes 1c to fasten (integrate) the upper shell 1A and the lower shell 1B.

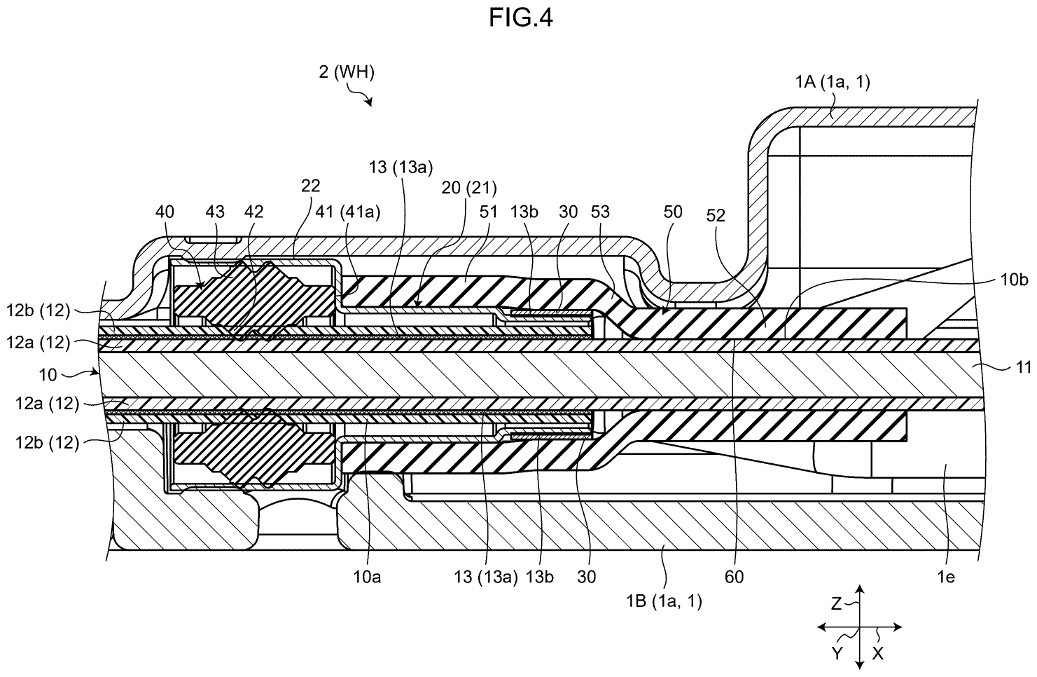

Here, in the present embodiment, a shield terminal 20, a shield ring 30 (refer to FIG. 4), a packing 40, and a shrink tube 50 are externally mounted on each of the plurality of shield electric wires 10. The shield terminal 20 is a terminal fitting made of a metal material having conductivity, and is grounded to the shield shell 1. The shield terminal 20 includes, for example, a cylindrical portion 21 (refer to FIG. 4) that covers the outer peripheral surface of the shield electric wire 10 and is housed in the shrink tube 50, and an exposed portion 22 that is provided at one end portion of the cylindrical portion 21 in the axial direction X and is exposed to the outside of the shrink tube 50.

In the present embodiment, the exposed portion 22 protrudes in a crank shape from one end portion side of the shrink tube 50 in the axial direction X along a side surface 41a and the outer peripheral surface of the packing 40 (packing main body 41). A distal end portion of the exposed portion 22 extends along an inner surface of the upper shell 1A and an inner surface of the lower shell 1B described above, and is grounded to the inner surface of the upper shell 1A and the inner surface of the lower shell 1B. In the shield terminal 20, for example, one sheet metal is molded by various processes such as pressing and bending in accordance with shapes corresponding to the respective portions of the cylindrical portion 21 and the exposed portion 22, and thereby the respective portions are three-dimensionally integrated.

FIG. 4 is a cross-sectional view illustrating the stacked body 2. As illustrated in FIG. 4, the shield electric wire 10 includes, for example, a linear conductor portion 11 having conductivity, an insulating coating portion 12 having insulation properties covering the outer side of the conductor portion 11, and a braided member 13 disposed between an inner layer 12a and an outer layer 12b of the insulating coating portion 12. Note that the conductor portion 11 of the present embodiment is a core wire obtained by bundling a plurality of metal wires having conductivity, but may be a stranded core wire obtained by twisting the plurality of metal wires. The insulating coating portion 12 is an electric wire coating that coats the outer peripheral side of the conductor portion 11.

The shield electric wire 10 extends linearly along the axial direction X and is formed to extend with substantially the same diameter with respect to the axial direction X (extending direction). In addition, in the shield electric wire 10, for example, a cross-sectional shape of the conductor portion 11 (cross-sectional shape intersecting the axial direction X) is formed in a substantially circular shape, and cross-sectional shapes of the insulating coating portion 12 and the braided member 13 are formed in a substantially annular shape, and the shield electric wire 10 is formed in a cross-sectional shape having a substantially circular shape as a whole. In the present embodiment, for example, the inner layer 12a of the insulating coating portion 12 and the conductor portion 11 constitute an electric wire body of the shield electric wire 10, and the outer layer 12b of the insulating coating portion 12 and the braided member 13 constitute a shield portion of the shield electric wire 10.

In addition, the shield electric wire 10 includes, for example, a first portion 10a and a second portion 10b. The first portion 10a is a portion of the shield electric wire 10, which is positioned closer to one end portion side in the axial direction X than the shield ring 30. The first portion 10a includes the conductor portion 11 and the inner layer 12a of the insulating coating portion 12 that constitute the electric wire body described above, and the braided member 13 and the outer layer 12b of the insulating coating portion 12 that constitute the shield portion, and is formed to have a relatively large diameter with respect to the second portion 10b.

The second portion 10b is a portion of the shield electric wire 10, which is positioned closer to the other end portion side in the axial direction X than the shield ring 30. The second portion 10b includes only the conductor portion 11 and the inner layer 12a of the insulating coating portion 12 that constitute the electric wire body described above, and is formed to have a relatively small diameter with respect to the first portion 10a. That is, the shield electric wire 10 includes a portion where the braided member 13 and the outer layer 12b of the insulating coating portion 12 that constitute the shield portion described above are peeled off in the axial direction X, and this portion constitutes the second portion 10b.

The braided member 13 is a shield layer formed by weaving a metal material having conductivity into a mesh shape. The braided member 13 includes, for example, a main body portion 13a that covers the outer peripheral surface of the inner layer 12a of the insulating coating portion 12 constituting the electric wire body described above, and a folded portion 13b that is provided at the other end portion of the main body portion 13a in the axial direction X and folded back along the outer peripheral surface of the shield terminal 20. The main body portion 13a is formed in, for example, a cylindrical shape extending along the axial direction X, and is interposed between the inner layer 12a and the outer layer 12b of the insulating coating portion 12. In the present embodiment, the main body portion 13a covers the conductor portion 11 of the shield electric wire 10 and the inner layer 12a of the insulating coating portion 12 over substantially the entire length of the shield electric wire 10, whereby the electric wire is configured as the shield electric wire 10.

The folded portion 13b is formed in, for example, a cylindrical shape extending along the axial direction X, and is interposed between the shield terminal 20 and the shield ring 30. The folded portion 13b is formed by folding back the other end portion of the main body portion 13a in the axial direction X to overlap the outer peripheral surface of the shield terminal 20. The length of the folded portion 13b along the axial direction X is substantially the same as the length of the shield ring 30 along the axial direction X. The main body portion 13a is also referred to as an inner shield portion or the like, and the folded portion 13b is also referred to as an outer shield portion or the like.

The shield ring 30 functions as a crimping ring that is crimped together with the braided member 13. The shield ring 30 is formed in, for example, a cylindrical shape along the outer peripheral surface of the shield terminal 20, and is crimped and fixed to sandwich the folded portion 13b of the braided member 13 between the shield ring 30 and the shield terminal 20. In the present embodiment, by crimping and fixing the shield ring 30, the folded portion 13b of the braided member 13, and the shield terminal 20, a stepped portion (recessed portion) along the radial direction (height direction Z) is formed in the shield terminal 20. In addition, by crimping and fixing the shield ring 30, the folded portion 13b of the braided member 13, and the shield terminal 20, the shield ring 30, the braided member 13, and the shield terminal 20 are conductively connected. The shield ring 30 is also referred to as a sleeve or the like.

The packing 40 suppresses entry of foreign matters such as moisture toward the crimped and fixed portion by the shield ring 30 described above. The packing 40 is formed of, for example, an elastically deformable member such as rubber or resin. For example, the packing 40 is formed in a cylindrical shape along the outer peripheral surface of the first portion 10a of the shield electric wire 10, and is fitted to the outer peripheral surface of the first portion 10a. That is, the packing 40 provides waterproof sealing with respect to the outer peripheral surface of the first portion 10a, which is positioned closer to the one end portion side in the axial direction X than the shield ring 30, of the shield electric wire 10, and suppresses the ingress of water toward the shield ring 30 from the outer peripheral surface of the first portion 10a.

In addition, the packing 40 includes, for example, the packing main body 41, an inner peripheral lip portion 42, and an outer peripheral lip portion 43. The inner peripheral lip portion 42 is a portion that protrudes inward in the radial direction from the inner peripheral surface of the packing main body 41 having a cylindrical shape, and performs sealing with respect to the outer peripheral surface of the first portion 10a. In the present embodiment, on the inner peripheral surface of the packing main body 41, two inner peripheral lip portions 42 are provided side by side in the axial direction X. The inner peripheral lip portion 42 is a pleated waterproof sealing portion formed in a substantially annular shape along the inner peripheral surface of the packing main body 41. In a state where the first portion 10a is inserted (press-fitted) into the packing main body 41, the inner peripheral lip portion 42 is in contact with the outer peripheral surface of the first portion 10a to perform waterproof sealing with respect to the outer peripheral surface. The inner peripheral lip portion 42 is configured to be in close contact with the outer peripheral surface of the first portion 10a by elastic deformation and seal an annular space between the outer peripheral surface and the inner peripheral surface of the packing main body 41.

The outer peripheral lip portion 43 is a portion that protrudes outward in the radial direction from the outer peripheral surface of the packing main body 41 and presses the exposed portion 22 of the shield terminal 20 against the shield shell 1 side. In the present embodiment, on the outer peripheral surface of the packing main body 41, two outer peripheral lip portions 43 are provided side by side in the axial direction X. In addition, the two outer peripheral lip portions 43 are aligned along the radial direction (height direction Z) with the two inner peripheral lip portions 42 described above. The outer peripheral lip portion 43 is a pleated waterproof sealing portion formed in a substantially annular shape along the outer peripheral surface of the packing main body 41. In a state where the packing main body 41 is housed in the shield shell 1 described above, the outer peripheral lip portion 43 is in contact with the inner peripheral surface of the exposed portion 22 to perform waterproof sealing with respect to the inner peripheral surface. The outer peripheral lip portion 43 is configured to be in close contact with the inner peripheral surface of the exposed portion 22 by elastic deformation and seal an annular space between the inner peripheral surface and the outer peripheral surface of the packing main body 41. In addition, the outer peripheral lip portion 43 is in close contact with the inner peripheral surface of the exposed portion 22 by elastic deformation, and presses the exposed portion 22 against the shield shell 1 side.

The shrink tube 50 is, for example, a heat shrink tube that shrinks along the radial direction (height direction Z) by heating, and suppresses entry of foreign matters such as moisture toward the crimped and fixed portion by the shield ring 30 described above. For example, the shrink tube 50 is formed in a cylindrical shape along the outer peripheral surface of the second portion 10b of the shield electric wire 10, and is closely fixed to the outer peripheral surface of the second portion 10b by heat shrinkage. In the present embodiment, the shrink tube 50 integrally covers the outer peripheral surface of the second portion 10b, the outer peripheral surface of the shield ring 30, and the outer peripheral surface of the shield terminal 20, and suppresses the ingress of water toward the shield ring 30 from the outer peripheral surface of the second portion 10b, which is positioned closer to the other end portion side in the axial direction X than the shield ring 30, of the shield electric wire 10.

The shrink tube 50 includes, for example, a first seal portion 51, a second seal portion 52, and a connection portion 53. The first seal portion 51 is a portion that integrally covers the outer peripheral surface of the shield ring 30 and the outer peripheral surface of the shield terminal 20 in the shrink tube 50 and performs sealing between the outer peripheral surface of the shield ring 30 and the outer peripheral surface of the shield terminal 20. The first seal portion 51 is formed in a cylindrical shape along the outer peripheral surface of the shield ring 30 and the outer peripheral surface of the shield terminal 20, and is formed to have a relatively large diameter with respect to the second seal portion 52.

The second seal portion 52 is a portion that covers the outer peripheral surface of the second portion 10b of the shield electric wire 10 in the shrink tube 50 and performs sealing with respect to the outer peripheral surface of the second portion 10b. The second seal portion 52 is formed in a cylindrical shape along the outer peripheral surface of the second portion 10b, and is formed to have a relatively small diameter with respect to the first seal portion 51. The connection portion 53 is a portion that is provided between the first seal portion 51 and the second seal portion 52 in the shrink tube 50 and connects the first seal portion 51 and the second seal portion 52. For example, the connection portion 53 is formed in a stepped shape recessed along the radial direction (height direction Z) of the shrink tube 50.

In addition, the shrink tube 50 includes, for example, a base material layer having a cylindrical shape, and an adhesive layer 60 provided on the inner peripheral surface of the base material layer. The base material layer is formed of, for example, a resin material that shrinks by heating, such as polyolefin or fluoropolymer. The adhesive layer 60 is formed of, for example, a hot melt adhesive, and more specifically formed of polyolefin such as polyethylene, thermoplastic polyester, an ethylene-vinyl acetate copolymer, polyamide, or the like. In the present embodiment, the adhesive layer 60 is provided over substantially the entire region of the inner peripheral surface of the shrink tube 50. That is, the adhesive layer 60 is provided on each of the inner peripheral surface of the first seal portion 51, the inner peripheral surface of the second seal portion 52, and the inner peripheral surface of the connection portion 53.

For example, the shrink tube 50 is formed in a cylindrical shape having a larger diameter than the outer peripheral surface of the shield terminal 20 in a state before being thermally shrunk by heating. Then, the first seal portion 51, the second seal portion 52, and the connection portion 53 can be formed by thermally shrinking the shrink tube 50 so that the shrink tube 50 is in close contact with the outer peripheral surface of the second portion 10b of the shield electric wire 10, the outer peripheral surface of the shield ring 30, and the outer peripheral surface of the shield terminal 20. As described above, in the present embodiment, by using the shrink tube 50, it is possible to relatively easily suppress the ingress of water toward the crimped and fixed portion by the shield ring 30.

Here, in a case where the pair of packings 40 is provided on both sides of the crimped and fixed portion by the shield ring 30 in the axial direction X, the packing 40 of various specifications corresponding to the electric wire diameter of the shield electric wire 10 is required, and there is a possibility that labor, cost, and the like required for manufacturing the wire harness WH are increased. In this regard, according to the present embodiment, the number of packings 40 can be reduced by using the shrink tube 50. As a result, there are advantages that labor, cost, and the like required for manufacturing the wire harness WH can be reduced, and that the wire harness WH can be configured to be smaller in the radial direction of the shield electric wire 10.

As described above, the wire harness WH of the present embodiment includes the packing 40 having the packing main body 41 that covers the outer peripheral surface of the first portion 10a of the shield electric wire 10, which is positioned closer to one end portion side of the shield electric wire 10 in the axial direction X than the shield ring 30, and having the inner peripheral lip portion 42 that protrudes inward in the radial direction from the inner peripheral surface of the packing main body 41 and performs sealing with respect to the outer peripheral surface of the first portion 10a, and the shrink tube 50 that integrally covers the outer peripheral surface of the second portion 10b of the shield electric wire 10, which is positioned closer to the other end portion side in the axial direction X than the shield ring 30, the outer peripheral surface of the shield ring 30, and the outer peripheral surface of the shield terminal 20, and that performs sealing with respect to the outer peripheral surface of the second portion 10b. With the configuration, in the wire harness WH, for example, it is possible to suppress the ingress of water toward the shield ring 30 from the outer peripheral surface of the first portion 10a of the shield electric wire 10, which is positioned closer to one end portion side in the axial direction X than the shield ring 30, by the packing 40, and it is possible to suppress the ingress of water toward the shield ring 30 from the outer peripheral surface of the second portion 10b of the shield electric wire 10, which is positioned closer to the other end portion side in the axial direction X than the shield ring 30, by the shrink tube 50. As a result, the wire harness WH can appropriately suppress the ingress of water to the crimped and fixed portion by the shield ring 30.

In addition, in the wire harness WH of the present embodiment, the shield terminal 20 includes the exposed portion 22 that protrudes in a crank shape from one end portion side of the shrink tube 50 in the axial direction X along the side surface 41a and the outer peripheral surface of the packing main body 41 and is grounded to the shield shell 1 (grounding target). With this configuration, in the wire harness WH, for example, the shield terminal 20 can be relatively easily grounded to the shield shell 1 positioned outside by the exposed portion 22.

In addition, in the wire harness WH of the present embodiment, the packing 40 has the outer peripheral lip portion 43 that protrudes outward in the radial direction from the outer peripheral surface of the packing main body 41 and presses the exposed portion 22 against the shield shell 1 side. With this configuration, the wire harness WH can more reliably hold a grounded state between the exposed portion 22 and the shield shell 1 by the elastic force of the outer peripheral lip portion 43, for example, and can suppress the ingress of water toward the shield ring 30 from a gap between the packing 40 and the shield terminal 20.

Note that in the present embodiment, the case where the wire harness WH includes two stacked bodies 2 and 3 stacked along the height direction Z has been exemplified, but the number of stacked bodies 2 and 3 is not limited to this example, and for example, the wire harness WH may include one or three or more stacked bodies 2 and 3.

Although the embodiments of the present invention have been exemplified above, the above embodiments are merely examples, and are not intended to limit the scope of the invention. The above-described embodiments can be implemented in various other forms, and various omissions, substitutions, combinations, and changes can be made without departing from the gist of the invention. In addition, specifications (structure, type, direction, form, size, length, width, thickness, height, number, arrangement, position, material, and the like) of each configuration, shape, and the like can be appropriately changed and implemented.

In a wire harness according to the present embodiment, for example, it is possible to suppress ingress of water toward a shield ring from an outer peripheral surface of a first portion of a shield electric wire, which is positioned closer to one end portion side in an axial direction than the shield ring, by a packing, and it is possible to suppress ingress of water toward the shield ring from an outer peripheral surface of a second portion of the shield electric wire, which is positioned closer to the other end portion side in the axial direction than the shield ring, by a shrink tube. As a result, the wire harness has an effect of appropriately suppressing the ingress of water to a crimped and fixed portion by the shield ring.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness comprising:
a shield electric wire that has a braided member;
a shield terminal that covers an outer peripheral surface of the shield electric wire, and is grounded to a grounding target;
a shield ring that is crimped and fixed to sandwich a folded portion of the braided member between the shield ring and the shield terminal, the folded portion being folded along an outer peripheral surface of the shield terminal;
a packing that has a packing main body that covers an outer peripheral surface of a first portion of the shield electric wire, the first portion being positioned closer to one end portion side of the shield electric wire in an axial direction than the shield ring, and has an inner peripheral lip portion that protrudes inward in a radial direction from an inner peripheral surface of the packing main body, and performs sealing with respect to an outer peripheral surface of the first portion; and
a shrink tube that integrally covers an outer peripheral surface of a second portion of the shield electric wire, the second portion being positioned closer to the other end portion side in the axial direction than the shield ring, an outer peripheral surface of the shield ring, and the outer peripheral surface of the shield terminal, and that performs sealing with respect to the outer peripheral surface of the second portion.

2. The wire harness according to claim 1, wherein
the shield terminal includes an exposed portion that protrudes in a crank shape from one end portion side of the shrink tube in the axial direction along a side surface and an outer peripheral surface of the packing main body, and is grounded to the grounding target.

3. The wire harness according to claim 2, wherein
the packing has an outer peripheral lip portion that protrudes outward in the radial direction from the outer peripheral surface of the packing main body, and presses the exposed portion against the grounding target side.
